(19) United States
(12) Patent Application Publication
(10) Pub. No.: US 2011/0048603 A1
(43) Pub. Date: Mar. 3, 2011

(54) PNEUMATIC VEHICLE TIRE FOR COMMERCIAL UTILITY VEHICLE

(75) Inventors: JENS KLEFFMANN, HANNOVER (DE); KLAUS PETERS, BURGDORF (DE); THOMAS BUCHINGER-BARNSTORF, WENNIGSEN (DE)

(73) Assignee: CONTINENTAL REIFEN DEUTSCHLAND GMBH, HANNOVER (DE)

(21) Appl. No.: 12/842,235

(22) Filed: Jul. 23, 2010

(30) Foreign Application Priority Data
Sep. 2, 2009 (EP) 09 169 199.8

(51) Int. Cl. B60C 11/13

(52) U.S. Cl. 152/209.21; 152/209.18; 152/209.27; 152/209.25

(57) ABSTRACT

A pneumatic vehicle tire for commercial utility vehicles has a tread with at least two circumferential grooves which run in the circumferential direction and divide the tread into circumferential ribs. A gross tread volume is defined by an envelope running in the tread parallel to the periphery of the tread and touching the lowest circumferential groove(s) from the inside radially, together with the periphery of the tread and flank portions at the shoulders. A groove volume is defined by all the grooves in the tread. The groove volume in the tread is between 1% and 10% of the gross tread volume.

### CROSS-REFERENCE TO RELATED APPLICATION

This application claims the priority, under 35 U.S.C. §119, of European patent application EP 09 169 199.8, filed Sep. 2, 2009; the prior application is herewith incorporated by reference in its entirety.

### BACKGROUND OF THE INVENTION

### Field of the Invention

The invention relates to a pneumatic vehicle tire for heavy duty, commercial utility vehicles. The tire has a tread with at least two circumferential grooves which run in the circumferential direction and divide the tread into circumferential ribs. A gross tread volume is defined by an envelope running in the tread parallel to the periphery of the tread and touching the lowest circumferential groove(s) from the inside radially, together with the periphery of the tread and flank portions at the shoulders. A groove volume is defined by all the grooves in the tread.

A tire of the generic type is described, for example, in U.S. Pat. No. 5,535,798. There, to achieve uniform abrasion of the tread, it is divided into circumferential ribs by four wide circumferential grooves running in the circumferential direction, a further, narrow circumferential groove that runs around in the circumferential direction being respectively provided in the two circumferential ribs at the shoulders, near the edges of the tread. The wide circumferential grooves are bounded by groove flank areas which are provided with depressions that are the negative of three-sided pyramids, the tips of which are facing the periphery of the tread.

In order to lower the rolling resistance of pneumatic vehicle tires, a large number of measures have already been proposed, for example reducing the profile depth or reducing the width of the tread. These measures are aimed at reducing the volume of rubber that has to be deformed during rolling. In addition, specific tread compounds reduce the rolling resistance, for example those which have a low filler content.

A large number of published patent applications and patents are concerned with the issue of lowering the rolling resistance of commercial vehicle tires in order to reduce the fuel consumption of a vehicle. For example, U.S. Pat. No. 6,415,834 B1 and its counterpart European patent EP 0 973 652 B1 describe a tire for driving wheels of heavy vehicles. The tread of the tire is divided into blocks which are passed through axially by slits, to reduce the rolling resistance. The blocks are also separated from one another by transverse grooves, which are respectively provided with further slits. In addition, a large number of longitudinal slits are provided.

The customary tires for commercial vehicles having treads with circumferential ribs and circumferential grooves have a groove volume which is at least 12% of the gross volume of the tread defined at the beginning. An increase in the volume of rubber of the tread at the expense of the groove volume would merely result in a prospective increase in the service life of the tire.

### SUMMARY OF THE INVENTION

It is accordingly an object of the invention to provide a pneumatic vehicle tire for heavy duty vehicles which overcomes the above-mentioned disadvantages of the heretofore-known devices and methods of this general type and which effectively lowers the rolling resistance of a commercial vehicle tire by simple measures, without the prospect of adverse effects on other properties of the tread as well as the abrasion and life expectancy of the tire.

With the foregoing and other objects in view there is provided, in accordance with the invention, a pneumatic vehicle tire for a commercial utility vehicle, comprising:

a tread formed with at least two circumferential grooves running in a circumferential direction of the tire and dividing the tread into circumferential ribs, the tread having a periphery and shoulders with flank portions;

an envelope running in the tread parallel to the periphery and touching a lowest the circumferential groove radially from inside, together with the periphery and the flank portions defining a gross tread volume;

a volume of all of the grooves formed in the tread together defining a groove volume; and

the groove volume in the tread amounting to between 1% and 10% of the gross tread volume.

In contrast with the existing consensus of those skilled in the art, in the case of the invention the rolling resistance is surprisingly reduced to a considerably degree by an increase in the volume of rubber in the tread. It has been found that, with a groove volume of up to 10% of the gross volume, the profile stiffness in the radial direction is increased in such a way that the deformation amplitude of the tread is reduced to an extent that more than compensates for the effect to be expected—worsening of the rolling resistance by more rubber being present. The rolling resistance of the tire is consequently lower, and it is possible for the reduction in the rolling resistance that can be achieved in comparison with a tire configured according to the prior art to be significant, depending on the proportion of the groove volume.

Since the proportion of the groove volume correlates with the achievable reduction in the rolling resistance of the tire, it is particularly advantageous according to a preferred embodiment of the invention if the proportion of the groove volume in relation to the gross volume is up to 7%.

The reduction in the rolling resistance is particularly significant in the case of configurations in which the proportion of the groove volume in relation to the gross volume is no more than and up to 4%.

In particular, the configuration of the circumferential grooves and the number thereof influence the size of the groove volume. In principle it is possible within the scope of the invention for there to be arranged in the tread at least one wide circumferential groove, the width of which at the periphery of the tread is between 5 mm and 20 mm and the depth of which is between 10 mm and 25 mm. Furthermore, in principle it is possible according to the invention for there to be provided in the tread at least one narrow circumferential groove, the width of which at or near the periphery of the tread is between 0.5 mm and 3 mm and the depth of which is likewise between 10 mm and 25 mm.

According to a preferred embodiment of the invention, up to seven circumferential grooves are provided in the tread.

If mainly or only narrow circumferential grooves are arranged in the tread as circumferential grooves, there are up to seven of them. In the case of configurations which mainly or only have wide circumferential grooves as circumferential grooves, there are up to four of them.

A tire configured according to the invention may therefore also have a combination of narrow and wide circumferential grooves in the tread, the respective number influencing the size of the groove volume.

The design-related configuration of the circumferential grooves also has an effect on the groove volume or the proportion of the groove volume in relation to the gross volume. The design-related or geometrical configuration of the circumferential grooves influences many important properties of the tread, for example the water drainage ability, the abrasion behavior, the traction properties, the rolling noise and the like. It is therefore important to configure the circumferential grooves in terms of their geometry or their cross section in such a way that, on the one hand, they keep the proportion of the groove volume in relation to the gross volume low according to the invention and, on the other hand, they ensure the desired properties of the tread. In this connection, it is of advantage according to the invention if the wide circumferential groove(s) has or have groove flanks which are provided with outwardly projecting design elements, for example elevations or sloping surfaces. In the case of narrow circumferential grooves, particularly advantageous are those configurations which have a groove cross section that widens in the radial direction starting from the periphery of the tread.

Wide circumferential grooves that can be formed with a relatively small groove volume are, for example, designed in such a way that they are respectively bounded at the periphery of the tread by two peripheral edges running parallel to one another and in a straight line and have a groove base running in a zigzag form in the circumferential direction.

Wide circumferential grooves are often critical with regard to catching stones. To effectively prevent stones from being caught, it is provided in the case of a preferred embodiment of the invention that the inwardly projecting corners of the groove base, projecting inward with respect to the peripheral edges, are respectively assigned the tip of a triangular area, which is inclined in relation to the radial direction and the one side of the triangle of which runs along a peripheral edge, these areas bounding the elevations, which protrude from both groove flanks into the circumferential groove.

The particular shaping of the elevations also contributes to preventing any stones from becoming caught in the circumferential grooves; in particular, it is favorable if the elevations are pyramidal in design and the triangular areas that are inclined in relation to the radial direction are in each case a side face of these elevations, the tips of which are located at a distance from the groove base that is at least 25% of the depth of the circumferential groove, two further pyramid faces adjoining the areas running from the peripheral edges, and two of these faces from adjacent elevations respectively having a common side, which runs from the peripheral edge to the groove base and forms a line of inflection.

A particularly advantageous structural variant of a tread that can be formed with a groove volume of, in particular, just under 7% has two wide circumferential grooves running at the shoulders and a third wide circumferential groove in the central region, a narrow circumferential groove respectively running between the wide circumferential grooves. A further embodiment that can have a groove volume of just under 7% has two wide circumferential grooves running at the shoulders and three narrow circumferential grooves between them.

In the case of these and other combinations of wide and narrow circumferential grooves in the tread, it is favorable if all the circumferential grooves have the same depths. The narrow circumferential grooves are then also effective on a worn tread.

In order to reduce the groove volume, it may be favorable to configure the circumferential grooves in the tread with different depths.

Treads according to the invention may have in the circumferential ribs transverse grooves, sipes and the like, the “air volume” of which contributes to the groove volume.

Other features which are considered as characteristic for the invention are set forth in the appended claims.

Although the invention is illustrated and described herein as embodied in a pneumatic vehicle tire for commercial vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a partial perspective view of an embodiment of a tread according to the invention;

FIG. 2 shows an enlarged view of a circumferential groove of the tread shown in FIG. 1,

FIG. 3 is a section taken along the line III-III in FIG. 2,

FIG. 4 is a section taken along the line IV-IV in FIG. 2,

FIG. 5 shows a view of a further embodiment of a tread according to the invention,

FIGS. 6-10 show cross sections of various configurational variants of circumferential grooves,

FIGS. 11a-11b show views of further embodiments of a tread configured according to the invention and

FIGS. 12-40 schematically show plan views of circumferential portions of treads with different configurational variants.

### DETAILED DESCRIPTION OF THE INVENTION

The invention is concerned with a particular configuration of treads for tires of heavy-duty, commercial utility vehicles, particularly trucks, buses and trailers. Tires configured according to the invention are preferably designed for use on the trailer or trailing axle of corresponding vehicles and may be of the customary construction of radial tires intended for these applications. The structural configuration of the tires themselves is therefore neither shown nor described.

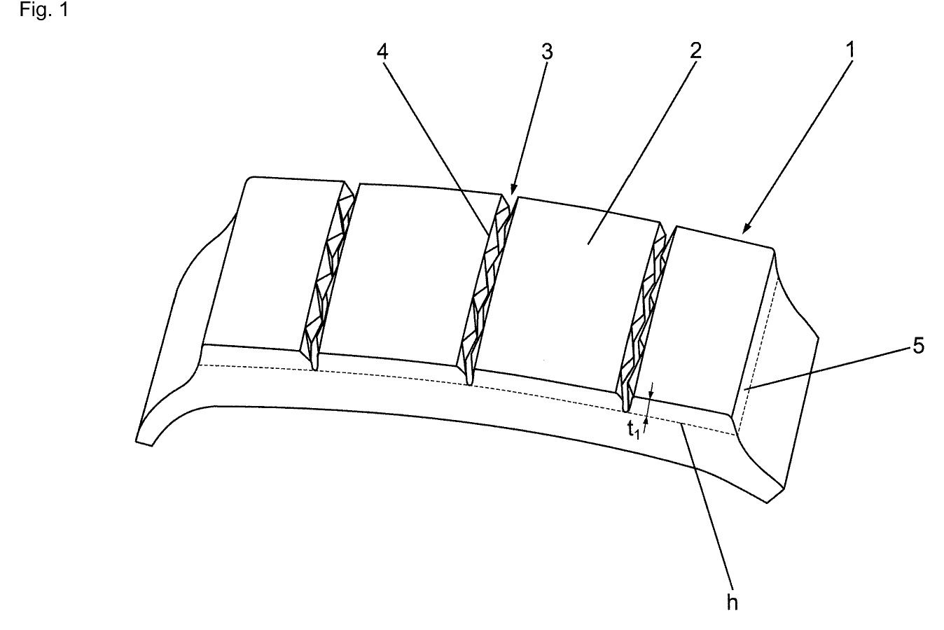

FIG. 1 to FIG. 4 show an embodiment of a tread 1 having four circumferential ribs 2 of substantially the same width running around in the circumferential direction of the tread. The circumferential ribs 2 are separated from one another by wide circumferential grooves 3, which run around in the circumferential direction and in the case of the configuration shown are all configured in the same way. The wide circumferential grooves 3 have peripheral edges 4 running straight and parallel to one another in the circumferential direction at the periphery of the tread, the mutual spacing b₁ of which—which corresponds to the width of the circumferential grooves 3 on new tires—is chosen between 5 mm and 20 mm. The maximum depth t₁ of the wide circumferential grooves 3, which in the case of the configuration shown is chosen to be of the same size for all the circumferential grooves 3, is between 10 mm and 25 mm. Depicted parallel to the axial outer contour of the periphery of the tread in FIG. 1 is an auxiliary line h, which touches the wide circumferential grooves 3 at their radially inner ends and in this way symbolizes in cross section an envelope running around parallel to the periphery of the tread in the circumferential direction within the tread 1.

The envelope symbolized by the auxiliary line h, the periphery of the tread and the flank portions 5 at the shoulders of the tread 1 enclose a gross volume V, which is the sum of the volume of rubber located here and of the groove volume V_{R}, which for its part is the sum of the “air volumes” of all the wide circumferential grooves 3—determined between the groove boundaries and an envelope of the periphery of the tread. In the case of a tire configured according to the invention, the proportion of the groove volume V_{R} in relation to the gross volume V is between 1% and 10%, preferably at most 7% and in particular between 1% and 4%. A tire configured according to the invention therefore has a tread with a small groove volume V_{R}.

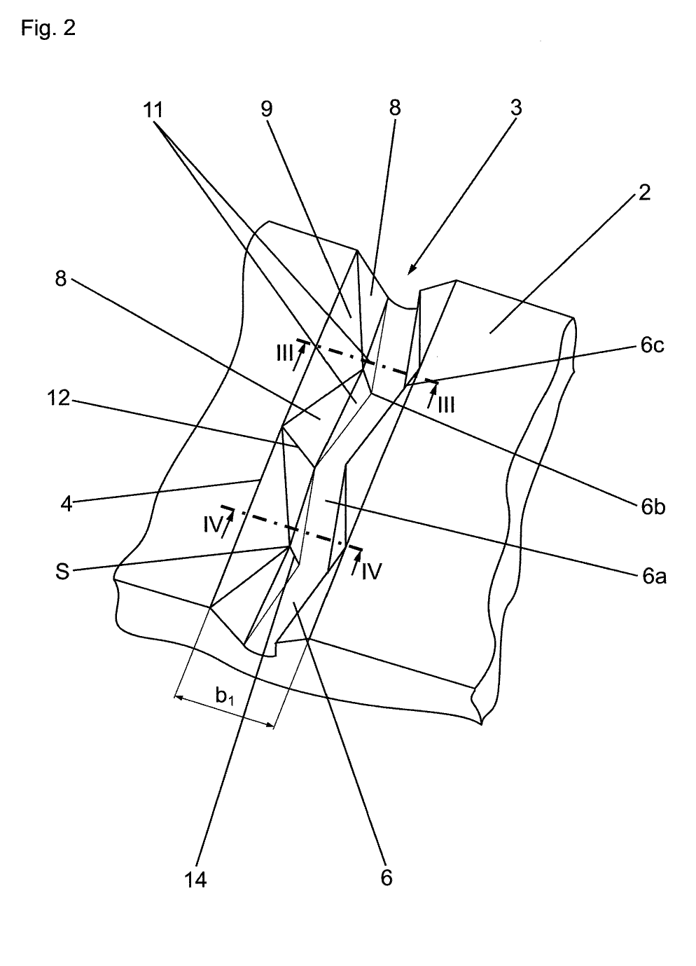

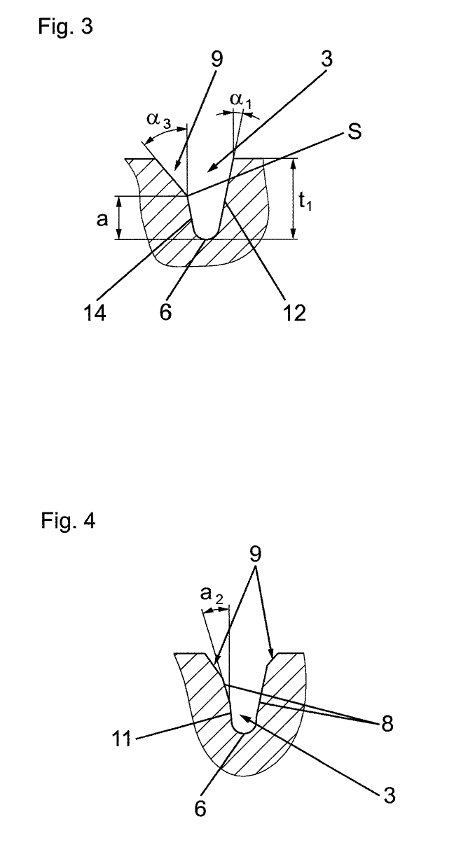

FIG. 1 to FIG. 4 show a preferred embodiment of a wide circumferential groove 3 with a small groove volume as a result of a particular shaping of the groove flanks. The wide circumferential groove 3 has a groove base 6, which is made up of portions 6a running in a zigzag form and is of a slightly rounded configuration in cross section (FIG. 3 and FIG. 4). The groove base 6 has a width of between 25% and 50% of the width b₁. The individual portions 6a, made to be of the same length, of the groove base 6 run at a small, acute angle of up to 20° in relation to the circumferential direction. The zigzag form of the groove base 6 correlates with the shaping of the two flanks of the circumferential groove 3. Formed on each groove flank is a series of elevations 7, which run in the circumferential direction and protrude pyramidally from the groove flanks. The tip S of each elevation 7 is assigned to an inwardly projecting corner 6b of the groove base 6. Here, five triangular areas, two areas 8 of the same size, one area 9 and two further areas 11 of the same size, respectively come together. The area 9 is the largest area and is an equilateral triangle, the hypotenuse of which coincides with the peripheral edge 4 concerned and runs inclined in relation to the radial direction at an angle α₃, which is between 15° and 45°.

At the corners 6c of the groove base 6 that project outward in the direction of the peripheral edges 4, lines of inflection 12 extend from the groove base 6 to the peripheral edges 4 at an angle α₁ of 2° to 10° in relation to the radial direction. The line of inflection 12 is at the same time a common side of the two triangular areas 8, which extend to the tips S and to the elevations 7 that are adjacent in the circumferential direction. The lines of inflection 12 reach as far as the corners of the areas 9 at the peripheral edges 4, so that two of the triangular areas 8 respectively come together at the tip S of an elevation 7. Viewed in cross section according to FIG. 4, the areas 8 are inclined with respect to the radial direction at an angle α₂, which is at least 2° less than the angle α₃ and is, in particular, between 10° and 35°. From the tip S of each elevation 7 there extends a further line of inflection 14 at the angle α₁ to the inwardly projecting corner 6b of the groove base 6. The line of inflection 14 is at the same time one of the side edges of the two further triangular areas 11, which run inclined in relation to the radial direction at the angle α₁ and are connecting areas between the areas 8 and the groove base 6.

The two groove flanks of the circumferential grooves 3 are provided in the same way with elevations 7, a line of inflection 12 on the one groove flank respectively lying opposite a line of inflection 14 and a tip S on the other groove flank.

The distance a of the tips S from the deepest point of the groove base 6 is between 25% and 80% of the depth t₁. The wave length of the zigzag form of the groove base 6 corresponds to the mutual spacing between two tips S and is between 15 mm and 80 mm.

Of particular advantage in the case of the wide circumferential grooves 3 shown in FIGS. 1 to 4 are the small groove volume and the specific geometry of the elevations 7, which effectively prevents gravel rock catching.

FIG. 5 shows a second embodiment of a tread 1 configured according to the invention. The tread 1 is divided into six circumferential ribs 2 by five narrow circumferential grooves 15 running around in a straight line in the circumferential direction. The two circumferential ribs 2 running at the shoulders are somewhat wider than the four circumferential ribs 2 running in the central region of the tread 1, which are of the same width. In the case of the configuration shown in FIG. 5, all the narrow circumferential grooves 15 are of the same configuration; by analogy with FIG. 1, an auxiliary line h forming a tangent to the radially inner ends of the circumferential grooves 15 symbolizes an envelope which runs around parallel to the periphery of the tread and, together with flank portions 5 at the shoulders and the periphery of the tread, encloses the gross volume V. Also in the case of this configurational variant, the groove volume V_{R}, as the sum of all the volumes of the narrow circumferential grooves 15, is between 1% and 10%, in particular up to 7% and preferably between 1% and 4%, of the gross volume V.

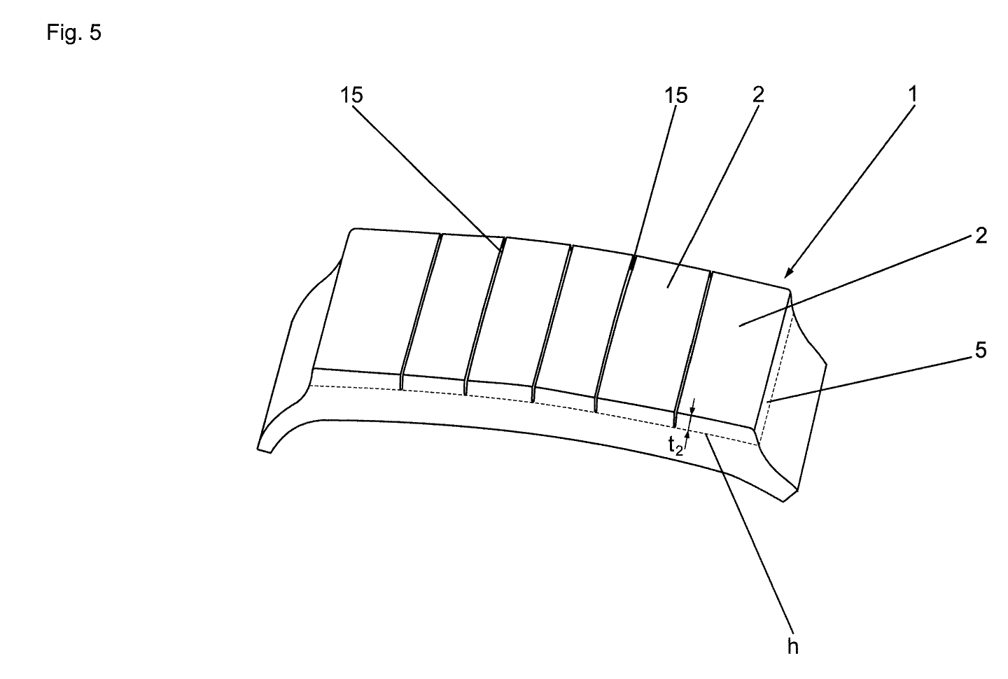

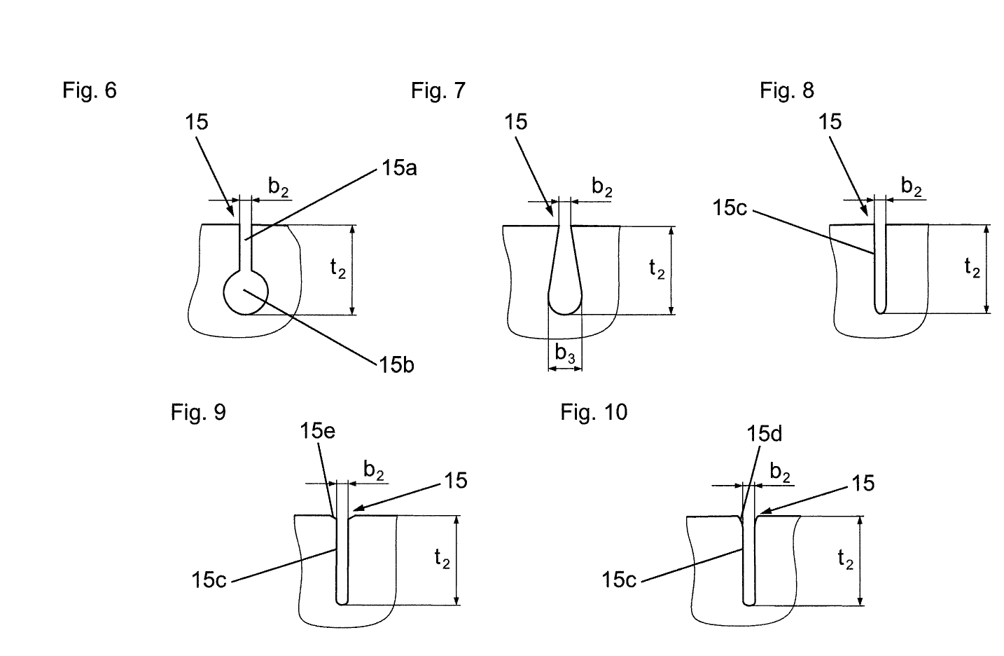

FIG. 6 to FIG. 9 show preferred configurational variants of cross-sectional forms of narrow circumferential grooves 15. A uniform cross-sectional form is preferably chosen for the circumferential grooves 15 of one and the same tire, but grooves with different cross sections may also be combined. In the case of all the configurational variants, the depth t₂ of the narrow circumferential grooves 15 is between 10 mm and 25 mm, the width b₂ of the narrow circumferential grooves 15 at the periphery of the tread is between 0.5 mm and 3 mm. If the transitional regions of the grooves 15 to the periphery of the tread are beveled or rounded, the width b₂ is determined at the radially inner end of the bevels 15c and roundings 15d and here is between 0.5 mm and 3 mm.

FIG. 6 shows a cross section of an embodiment of the narrow circumferential groove 15 which, viewed from the periphery of the tread and in the radial direction, has two groove portions 15a and 15b, the groove portion 15a that adjoins the periphery of the tread running over 40% to 90% of the depth t₂ and being a portion with constant width, the width b₂. The groove portion 15a opens out into the groove portion 15b, which has a cross-sectional area of an approximately circular configuration, the size of which is between two and ten times the cross-sectional area of the groove portion 15a. The groove portion 15b may also have a different cross-sectional form, for example a rectangular, oval or approximately triangular form.

In the case of the configurational variant shown in FIG. 7, the narrow circumferential groove 15 has a cross section in the form of a drop, in such a way that the width of the narrow circumferential groove 15 increases continuously in the radial direction, the point with the greatest width b₃ being between 1 mm and 6 mm wide.

FIGS. 8, 9 and 10 show embodiments in which the narrow circumferential groove 15 is bounded by two groove flanks 15c running in the radial direction and parallel to one another, so that the circumferential groove 15 has a constant width, the width b₂, over the majority of its radial extent. In the case of the configurational variant shown in FIG. 9, the transitions of the groove flanks 15c to the periphery of the tread are beveled outward (bevels 15e), in FIG. 10 they are provided with roundings 15d.

FIG. 11A shows a configurational variant of a tread 1 which has three wide circumferential grooves 3, configured according to FIGS. 2 to 4, and two narrow circumferential grooves 15, configured according to FIG. 8, in combination. The circumferential ribs 2 running at the shoulders are respectively followed by a wide circumferential groove 3; the third wide circumferential groove 3 runs in the center of the tread, along the equator of the tire. Running between this wide circumferential groove 3 and each of the circumferential grooves 3 at the shoulders are two circumferential ribs 2, which are in each case separated from one another by a narrow circumferential groove 15. FIG. 11B shows a variant of FIG. 11A in which the central circumferential groove is a narrow circumferential groove 15. In FIG. 11A and FIG. 11B, the envelope respectively symbolized by the auxiliary line h touches the radially inner ends of the circumferential grooves 3 and 15, configured with the same depths t₁, t₂. These two configurational variants can be formed in particular in such a way that the entire groove volume V_{R} is just below 7% of the gross volume V.

Tires configured according to the invention may therefore have treads in which a combination of wide and narrow circumferential grooves 3 and 15 divides the tread 1 into circumferential ribs 2, but it is also possible for only wide circumferential grooves 3 or only narrow circumferential grooves 15 to be provided in the tread 1.

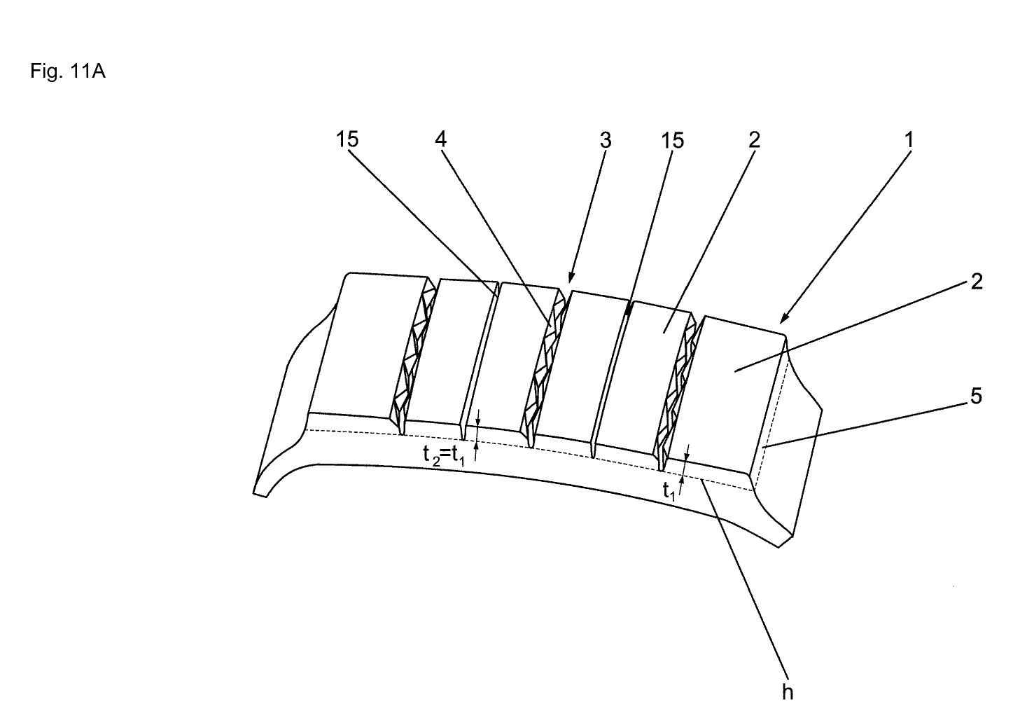

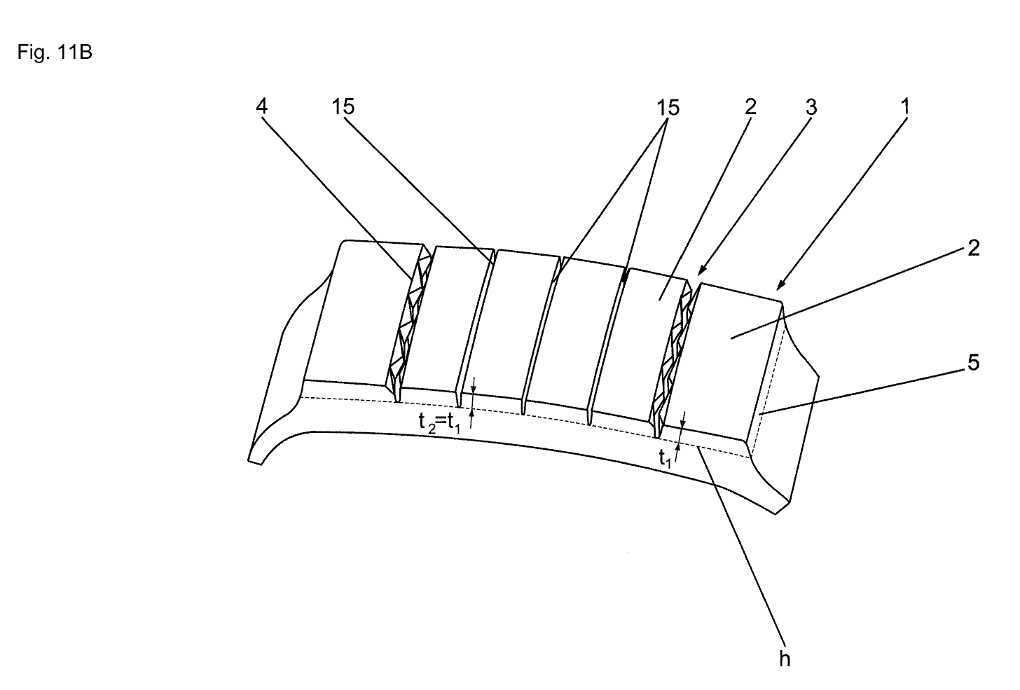

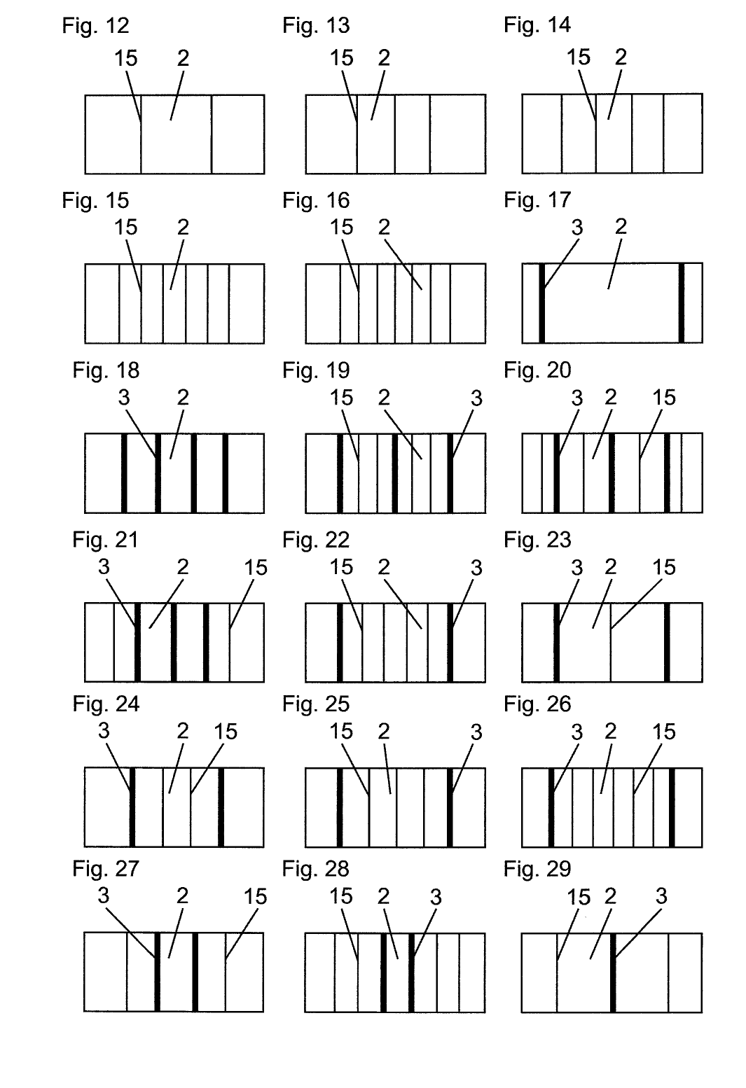

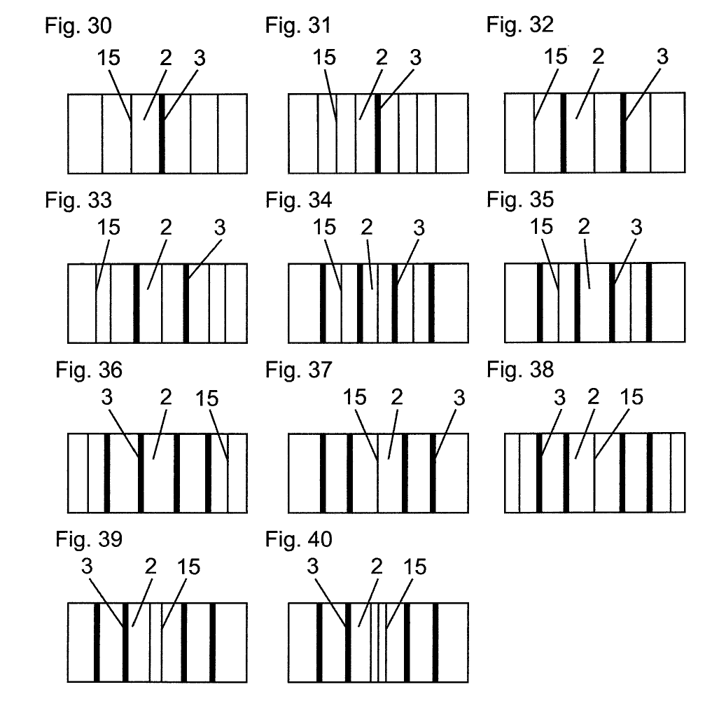

In the case of a configuration of the tread 1 with narrow circumferential grooves 15, the tread 1 may be divided into circumferential ribs 2 by two to seven narrow circumferential grooves 15. FIG. 12 shows a configuration with two narrow circumferential grooves 15, FIG. 13 with three, FIG. 14 with four, FIG. 15 with six and FIG. 16 with seven circumferential grooves 15. In particular, the circumferential ribs 2 formed between the narrow circumferential grooves 15 are configured with substantially the same width. In the case of treads 1 that only have wide circumferential grooves 3, between two and four wide circumferential grooves 3 are optimal. FIG. 17 shows a configurational variant with two wide circumferential grooves 3, which run near the shoulders, FIG. 18 shows a configuration with four wide circumferential grooves 3. Configurations with combinations of narrow and wide circumferential grooves 3, 15 may be of very different and varied configurations. FIG. 19 shows a tread 1 with three wide circumferential grooves 3, a pair of narrow circumferential grooves 15 respectively running between the wide circumferential grooves 3, FIG. 20 shows a tread 1 with three wide circumferential grooves 3 alternating or in combination with four narrow circumferential grooves 15, FIG. 21 shows a configuration with three wide circumferential grooves 3 in the central region of the tread 1 and a narrow circumferential groove 15 respectively at the shoulders. FIG. 23 to FIG. 26 show variants with two wide circumferential grooves 3 running at the shoulders in combination with one to five narrow circumferential groove(s) 15 running between the wide circumferential grooves 3, FIG. 27 and FIG. 28 show two wide circumferential grooves 3 in this central region of the tread 1 in combination with one or two narrow circumferential grooves 15 respectively at the shoulders, FIG. 29 to FIG. 31 show variants with a wide circumferential groove 3 in the center of the tread 1 and in each case between one and three narrow circumferential grooves 15 to the sides of this central, wide circumferential groove 3, FIG. 32 and FIG. 33 show combinations of two wide circumferential grooves 3 in the central region of the tread 1 with a central, narrow circumferential groove 15 and one or two narrow circumferential groove(s) 15 running at the shoulders, FIG. 34 to FIG. 40 show treads 1 with combinations of four wide circumferential grooves 3 with one to three narrow circumferential grooves 15, in FIG. 34 the narrow circumferential grooves 15 running between the wide circumferential grooves 3, in FIG. 35 a narrow circumferential groove 15 respectively running between the pairs of wide circumferential grooves 3 on the outsides of the tread, in FIG. 36 a narrow circumferential groove 15 being in each case the circumferential groove running at the shoulder, in FIG. 37 a single narrow circumferential groove 15 running in the center of the tread, in FIG. 38 a narrow circumferential groove 15 running in the center of the tread and a further narrow circumferential groove 15 respectively running at the shoulders, in FIG. 39 two narrow circumferential grooves 15 running in the center of the tread and in FIG. 40 three narrow circumferential grooves 15 running in the center of the tread, in each case next to one another.

With two reference tires R₁ and R₂ and a tire R_{E} configured according to the invention, in the configuration according to FIG. 1, tests are carried out to determine the rolling resistance. The tires R₁ and R₂ had the customary, cross-sectionally approximately U-shaped, circumferential grooves. The tire R₂ had a 7% higher abrasion volume than the tire R₁. In comparison with the tire R₁, the tire R₂ had an approximately 2% greater rolling resistance (Table 1).

TABLE 1

| | | Reference tire |
|---|---|---|
| | Reference tire R₁ | R₂ |
| Profile depth | 15 mm | 16 mm |
| Abrasion volume (V-V_{R}) | 100% | 107% |
| V_{R} | 13% | 13% |
| Change in rolling | — | +2.5% |
| resistance | | (worsening) |

Table 2 shows a comparison of the reference tire R₁ with the tire R_{E} configured according to the invention. Both tires had a profile depth of 15 mm; the groove volume V_{R} of the reference tire R₁ was 13%, that of the tire R_{E} according to the invention 6%. The tire R_{E} had a 7% greater abrasion volume than the reference tire R₁. The determined rolling resistance of the tire R_{E} was 2% less than that of the tire R₁.

TABLE 2

| | Reference tire R₁ | Tire R_{E} |
|---|---|---|
| Profile depth | 15 mm | 15 mm |
| V_{R} | 13% | 6% |
| Abrasion volume (V-V_{R)} | 100% | 107% |
| Change in rolling | — | −2% |
| resistance | | (improvement) |

The low groove volume V_{R} in the case of the tire configured according to the invention has the effect that the volume of rubber offered in the tread 1 is correspondingly higher. With a higher volume of rubber, in principle a worsening of the rolling resistance can be expected, since more rubber has to be deformed as the tire runs through the area of contact with the ground, and consequently more energy is distributed in the tread 1. In the case of the tire configured according to the invention, the groove volume V_{R} is reduced to an extent that the profile stiffness in the radial direction is significantly increased, whereby the deformation amplitude of the tread 1 is significantly reduced. This effect more than compensates for the worsening “to be expected” of the rolling resistance by far, so that the rolling resistance as a whole falls significantly.

In the case of tires configured according to the invention, the width of the two circumferential ribs 2 situated at the shoulders—measured at that point where the shoulder ribs have their smallest width—should in each case be at most 30% of the overall width of the tread. One or more of the circumferential grooves 3, 15 provided may, furthermore, also run over the circumference of the tire in a zigzag or wave form, the portions of the circumferential grooves that are created by the zigzag form being intended to form an included angle with the circumferential direction that is at most 60°. Circumferential ribs may be additionally provided with grooves running in the transverse direction of the tread or narrow sipes, the “air volume” of which is included in the groove volume V_{R}.

The embodiments shown and described for wide and narrow circumferential grooves are preferred examples. The circumferential grooves may also be configured differently; in particular, wide circumferential grooves may have differently configured elevations on the groove flanks or elevations at the groove base, which keep the “air volume” formed by the grooves together with an envelope at the periphery of the tread, the groove volume V_{R}, relatively small.

Viewed over the circumference of the tire, the circumferential grooves may, furthermore, have portions of different widths. For example, narrow circumferential grooves may be made somewhat wider at regular intervals, in order to be able to determine the remaining profile depth more easily with a profile depth gage. Furthermore, in some or all of the circumferential grooves there may be so-called wear indicators (rubber bars) or re-groove indicators (depressions), which indicate the maximum allowed re-groove depth.

1. A pneumatic vehicle tire for a commercial utility vehicle, comprising:
a tread formed with at least two circumferential grooves running in a circumferential direction of the tire and dividing said tread into circumferential ribs, said tread having a periphery and shoulders with flank portions;
an envelope running in said tread parallel to said periphery and touching a lowest said circumferential groove radially from inside, together with said periphery and said flank portions defining a gross tread volume;
a volume of all of said grooves formed in said tread together defining a groove volume; and
said groove volume in said tread amounting to between 1% and 10% of said gross tread volume.

2. The pneumatic vehicle tire according to claim 1, wherein a proportion of said groove volume in relation to said gross tread volume is up to 7%.

3. The pneumatic vehicle tire according to claim 1, wherein a proportion of said groove volume in relation to said gross tread volume is up to 4%.

4. The pneumatic vehicle tire according to claim 1, wherein said grooves in said tread include at least one wide circumferential groove having a width, defined at said periphery of said tread, between 5 mm and 20 mm and a depth between 10 mm and 25 mm.

5. The pneumatic vehicle tire according to claim 1, wherein said grooves in said tread include at least one narrow circumferential groove having a width at or near said periphery of said tread between 0.5 mm and 3 mm and a depth between 10 mm and 25 mm.

6. The pneumatic vehicle tire according to claim 1, wherein said at least two circumferential grooves are up to seven circumferential grooves formed in said tread.

7. The pneumatic vehicle tire according to claim 5, wherein said tread is formed only with said narrow circumferential grooves, and said at least two circumferential grooves are between two and seven circumferential grooves.

8. The pneumatic vehicle tire according to claim 4, wherein said tread is formed only with wide circumferential grooves, and said at least two circumferential grooves are from two to four circumferential grooves.

9. The pneumatic vehicle tire according to claim 1, wherein said grooves in said tread include relatively narrow circumferential grooves and one or more relatively wide circumferential grooves, each said relatively wide circumferential groove having a width, defined at said periphery of said tread, between 5 mm and 20 mm and a depth between 10 mm and 25 mm, and said relatively narrow circumferential grooves each having a width, at or near said periphery of said tread, between 0.5 mm and 3 mm and a depth between 10 mm and 25 mm.

10. The pneumatic vehicle tire according to claim 4, wherein said one or more wide circumferential grooves have groove flanks provided with outwardly projecting design elements reducing the groove volume.

11. The pneumatic vehicle tire according to claim 10, wherein said design elements are selected from the group consisting of elevations and sloping surfaces.

12. The pneumatic vehicle tire according to claim 4, wherein said one or more wide circumferential grooves are respectively bounded at said periphery of said tread by two peripheral edges running parallel to one another and in a straight line, and are formed with a groove base running in a zigzag form in the circumferential direction.

13. The pneumatic vehicle tire according to claim 12, wherein inwardly projecting corners of said groove base, projecting inward with respect to peripheral edges, are respectively assigned a tip of a triangular area that is inclined in relation to the radial direction and having one side of a triangle running along a peripheral edge, said triangular areas bounding elevations projecting from groove flanks into said circumferential groove.

14. The pneumatic vehicle tire according to claim 13, wherein said elevations are pyramid-shaped elevations and said triangular areas that are inclined in relation to the radial direction are in each case a side face of said elevations, the tips of which are located at a distance from said groove base that is at least 25% of the depth, two further pyramid faces adjoining said triangular areas running from said peripheral edges, and two of said faces from adjacent elevations respectively having a common side, which runs from said peripheral edge to said groove base and forms a line of inflection.

15. The pneumatic vehicle tire according to claim 5, wherein each of said narrow circumferential grooves has a groove cross section that widens inwardly in the radial direction starting from said periphery of the tread.

16. The pneumatic vehicle tire according to claim 9, wherein said tread is formed with a wide circumferential grooves running at each of said shoulders, a third wide circumferential groove in a central region, and a narrow circumferential groove respectively running between said wide circumferential grooves.

17. The pneumatic vehicle tire according to claim 9, wherein said tread is formed with two wide circumferential grooves running at the shoulders and three narrow circumferential grooves between said two wide circumferential grooves.

18. The pneumatic vehicle tire according to claim 1, wherein said circumferential grooves in said tread have a common depth.

19. The pneumatic vehicle tire according to claim 1, wherein said circumferential grooves in said tread have mutually different depths.

20. The pneumatic vehicle tire according to claim 1, wherein said circumferential ribs are formed with at least one of transverse grooves and sipes.
